(19) United States
(12) Patent Application Publication
(10) Pub. No.: US 2008/0053219 A1
(43) Pub. Date: Mar. 6, 2008

(54) Multifunction fuel sensor

(76) Inventors: Hugh W. Ireland, Clio, MI (US); Ulf Sawert, Grand Blanc, MI (US)

Correspondence Address: Patrick M. Grifin, Esq.;Delphi Technologies, Inc., Mail Code 480410202, P.O. Box 5052, Troy, MI, 48007, US

(21) Appl. No.: 11/516,133

(22) Filed: Sep. 6, 2006

(51) Int. Cl. G01F 23/00

(52) U.S. Cl. 73/313

(57) ABSTRACT

A multifunction fuel gauge has a rotating wiper assembly turned by a float in a fuel tank, the wiper assembly having two wiper contacts having different radial lengths which make contact with a plurality of contacts which form two concentric arcuate rows on a board. The first row has several contacts connected to a resistive element to provide a voltage signal to a fuel gauge. The second row has at least one conductive strip which has a width such that one of the wiper contacts makes electrical contact with the conductive strip for a portion of the arc transversed by the wiper assembly. This contact can be used, for example, as a low fuel sensor.

### TECHNICAL FIELD

The present invention relates to fuel sensors; more particularly, to the reostat in fuel sensors; and most particularly, to variable resistance reostats in multifunction fuel sensors used in a fuel storage tank.

### BACKGROUND OF THE INVENTION

The most commonly used technology to measure the level of fuel in a vehicle's fuel tank is to utilize a thick film variable resistor whose output changes with the rotation of a wiper assembly connected to a float and float arm assembly which move as the level of the fuel within the tank rises and falls. Thick film variable resistance fuel sensors are shown in U.S. Pat. No. 6,681,628 to Sawert et al. and U.S. Pat. No. 6,886,403 to LaBarge et al., both of which are incorporated by reference to the extent that they do not conflict with the teachings herein.

To date, only the fuel level is reported to the outside environment via the fuel level sensor. Additional functions, such as a low fuel warning function, actuation of a system leak check function or activation of an auxiliary fuel tank pump require additional components. For example, one component that is used as a low fuel warning switch is a thermistor which is mounted at the required fuel level and independent of the system for gauging fuel level.

It is a principal object of the present invention to provide a fuel sensor that provides electrical signals to two or more fuel level dependent components of a vehicle.

### SUMMARY OF THE INVENTION

Briefly described, a multifunction fuel sensor according to an embodiment of the present invention includes a first float position sensor that provides an electrical signal to a fuel gauge indicating one of a plurality of float positions and one or more additional float position sensors which provide one of more independent voltage signals for controlling components that depend on the position of the float.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a fragmentary elevational view of a multifunction fuel sensor according to the invention, illustrated in operational relationship with a vehicle fuel tank;

FIG. 2 is a top view of a multi-function fuel sensor according to an embodiment of the current invention;

FIG. 3 is a perspective view of a portion of a fuel sensor housing containing the multi-function fuel sensor shown in FIG. 2; and

FIG. 4 is a more detailed perspective view of a portion of the fuel sensor housing shown in FIG. 3.

Corresponding reference characters indicate corresponding parts throughout the several views. The exemplification set out herein illustrates a currently-preferred embodiment of the invention, and such exemplification is not to be construed as limiting the scope of the invention in any manner.

### DESCRIPTION OF THE PREFERRED EMBODIMENTS

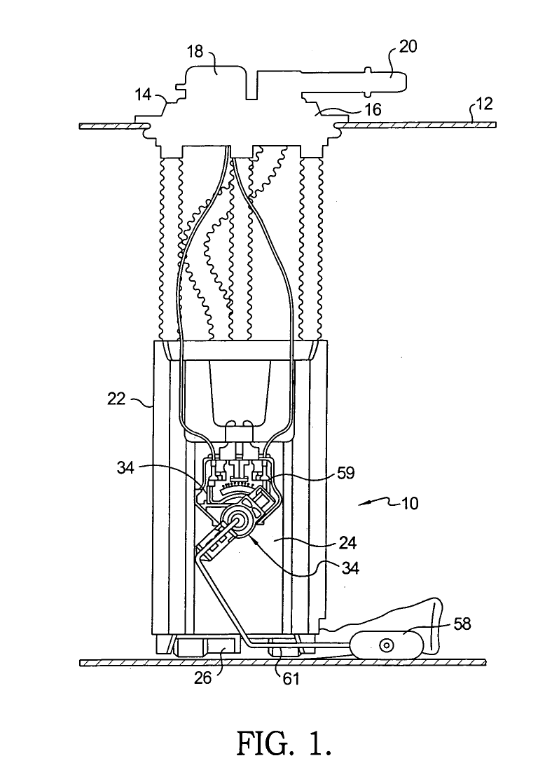

Referring to FIG. 1, fuel tank 12 (partially shown) includes a fuel pump module 14 therein with a removable cover 16 sealed to the top of the fuel tank 12 with an electrical connector 18 and a fuel line outlet connector 20. Included in tank 12 is fuel reservoir 22 that contains an electric fuel pump 24 with an inlet 26 and fuel multifunction fuel sensor 10. It should be appreciated that, except for the multifunction fuel sensor 10, the fuel tank 12 is conventional and known in the art.

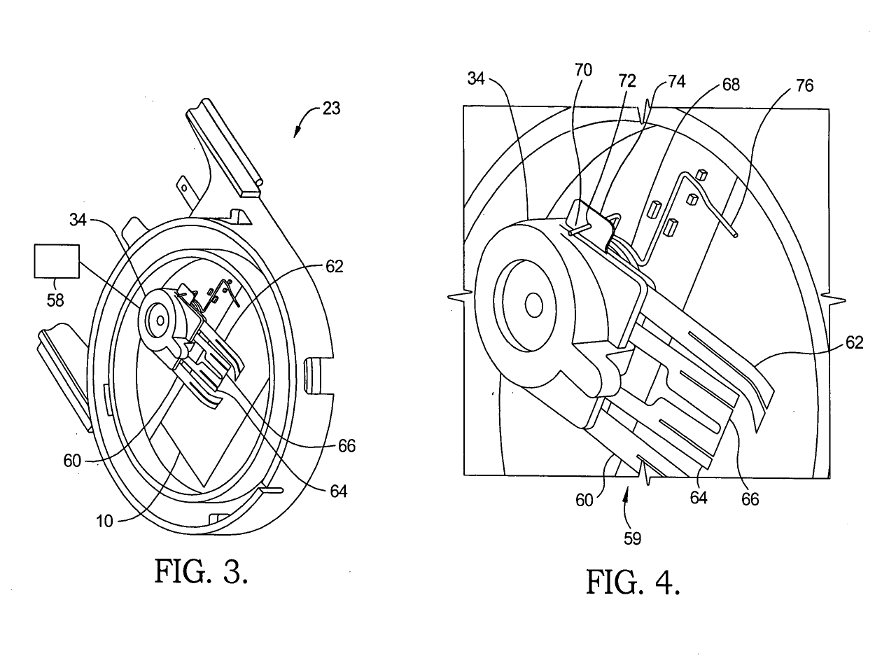

Referring to FIGS. 1 through 4, contained in fuel sensor housing 23 is multifunction fuel sensor 10. Multifunction fuel sensor 10 includes a thick film variable resistor fuel level sensing circuit 28 and additional conductive tracks 30 and 32 which selectively make contact with at least one wiper blade mounted on a rotating wiper assembly 34 shown in FIGS. 3 and 4 to be described later. Sensor 10 also includes ground track 36. The thick film variable resistor fuel level sensing circuit 28 includes a thick film arcuate strip resistor 38 which makes electrical contact at one end thereof to a conductive track 40 which, in turn, is coupled through a surface mounted resistor 42 to a wire attachment pad 44. A plurality of metal strips 46 are laid side by side along an arc with each strip having a wiper blade contact region and a region of contact with the thick film strip resistor 38 such that the resistance between each of the metal strips 46 and the pad 44 varies depending on the placement of the contact of the metal strip 46 along the thick film strip resistor 38. As the rotating wiper assembly 34 rotates, the resistance changes between the wiper blades making contact with the wiper blade contact region of the metal strips 46 and the pad 44.

The conductive track 30 extends to a wire attachment pad 47, and the conductive track 32 extends to a wire attachment pad 48. Ground track 36 has a wire attachment pad 50 and a contact pad 52.

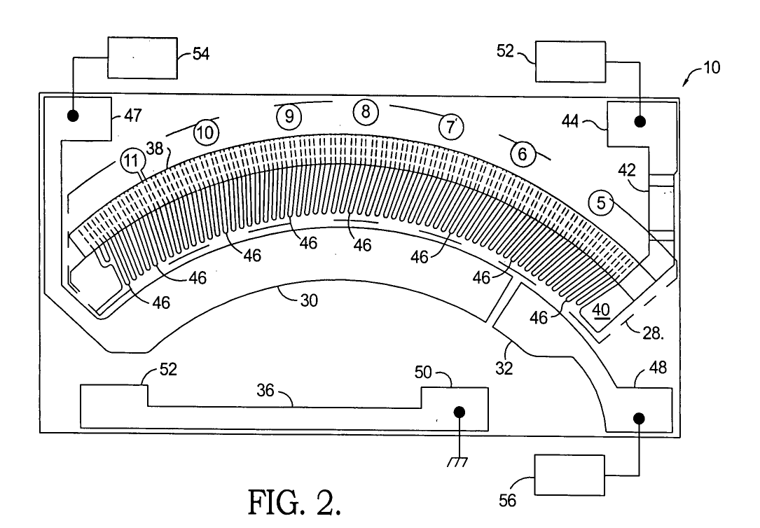

Also shown in FIG. 2 is a fuel gauge 52 electrically connected to the pad 44. Additional components whose operations are dependent on fuel level and whose functions are controlled by multifunction fuel sensor 10 include, by way of example only, an optional auxiliary fuel pump 54 electrically connected to pad 47 for pumping fuel from an auxiliary fuel tank into the main fuel tank and a low fuel level indicator 56 for illuminating a dash board warning light electrically connected to the pad 48. Other components that are not illustrated may be controlled by multifunction fuel level sensor 10 whose operations are dependent on fuel level, such as for example an on-board system for testing fuel tank leakage. In one aspect of the invention, pad 50 is connected to chassis ground, although a voltage other than chassis ground can be applied to pad 50.

FIG. 3 is a perspective view of a portion of a fuel sensor housing 23 containing the multifunction fuel sensor 10 and the rotating wiper assembly 34. A fuel float 58 (FIG. 1) is mechanically connected to the rotating wiper assembly 34 such that the rotational position of the rotating wiper assembly 34 is controlled by the position of the fuel float 58.

FIG. 4 is a more detailed perspective view of a portion of the fuel sensor housing 23 shown in FIG. 3. The rotating wiper assembly 34 includes blade member 59. In the example shown, blade member 59 includes wiper blades 60 and 62 which make contact with the wiper blade contact regions of the metal strips 46 in the thick film variable resistor fuel level sensing circuit 28. Blade member 59 also includes two connected wiper blades 64 and 66 which make selective contact with the conductive tracks 30 and 32. Blade member 59 also includes plate 74. In the example shown, blades 60, 62, 64 and 66 and plate 74 are formed as one piece from a conductive metal. A coiled spring 68, which surrounds the lower portion of the rotating wiper assembly 34, has a vertical first end 70 which extends through an opening 72 in plate 74, and makes electrical contact with, plate 74. The other end 76 of the spring 68 presses down on the contact pad 52 of the multi-function fuel sensor 10 thus forming an electrical connection between at least some of the wiper blades 60-66 and the wire attachment pad 50.

In operation, the resistance between the wire attachment pads 44 and 50 shown in FIG. 2 varies as the rotating wiper assembly 34 rotates, the rotating wiper assembly being mechanically rotated by the fuel float 58 through connecting rod 61 in the fuel tank of the vehicle. Depending on the position of the wiper blades 64 and 66 there may or may not be an electrical connection between the wire attachment pad 50 and the wire attachment pads 47 and 48.

In an exemplary aspect of the invention, conductive track 32 may be used to detect a low fuel level to, in turn, control a low fuel warning light on the dashboard of the vehicle. In another exemplary aspect of the invention, conductive track 30 may be used to control a pump which pumps fuel from an auxiliary fuel tank to the main fuel tank. For example, when the fuel tank is full, the pad 47 is at chassis ground potential and the pad 48 is at some voltage other than chassis ground. These voltage levels disable the fuel pump 54 and the low fuel indicator 56. Also, when the fuel tank is full, the resistance from the pad 50 to pad 44 is at its maximum and the fuel gauge 52 will indicate a full fuel tank.

In another example, conductive track 30 may be used to detect when the fuel level is between one-third and two-thirds full and thereby complete (or open) a circuit to signify a period suitable for conducting an onboard check for tank leakage.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A multifunction fuel sensor comprising:
a) a first float position sensor that provides an electrical signal to a fuel gauge that indicates one of a plurality of float positions, and
b) a second float position sensor which provides a second voltage level depending on the position of said float independent of said electrical signal.

2. A multifunction fuel sensor according to claim 1 further including a third float position sensor which provides a third voltage level depending on the position of said float independent of said electrical signal.

3. A multifunction fuel sensor according to claim 1 wherein said second float position sensor is coupled to a low fuel warning indicator.

4. A multifunction fuel sensor according to claim 1 wherein said second float position sensor is coupled to a fuel pump.

5. A multifunction fuel sensor according to claim 1 wherein said first float position sensor includes a plurality of contacts forming an arc.

6. A multifunction fuel sensor according to claim 5 wherein said second float position sensor includes at least one arc shaped contact which is concentric with said plurality of contacts.

7. A multifunction fuel sensor according to claim 6 further including a plurality of wiper contacts with different radial lengths attached to a rotating assembly which is mechanically coupled to said float.
